(19) United States
(12) Patent Application Publication
(10) Pub. No.: US 2016/0037783 A1
(43) Pub. Date: Feb. 11, 2016

(54) Taco/Tortilla Shell Fryer/Baking Grill and Prep & Serving Stand

(71) Applicant: Larry Drees, Reno, NV (US)

(72) Inventor: Larry Drees, Reno, NV (US)

(21) Appl. No.: 14/456,776

(22) Filed: Aug. 11, 2014

(51) Int. Cl. A21B 5/00

(52) U.S. Cl. CPC A21B 5/00

(57) ABSTRACT

This tortilla cooking utensil functions uniquely with all metal wire grates and O-rings. The O-rings allow the device to open, secure the tortilla, and close the device. The reduced size allows for simultaneous preparation of multiple shells with multiple devices. The device may also be used as an individual preparation and serving stand. The elimination of perforated metal plates and utensil handles makes the utensil less expensive to produce and easier for storage. The elimination of materials such as wood, plastic and other high-heat sensitive materials avoids heat damage to the device.

### PRIORITY CLAIM

Applicant hereby claims priority with respect to provisional application No. 61/675,290 filed Jul. 24, 2012

### CROSS-REFERENCE TO RELATED APPLICATIONS

| Patent # | Pat Date | Name |
|---|---|---|
| 7,866,257 | Jan. 11, 2011 | Vasquez |
| D607,287 | Jan. 5, 2010 | Beasley, et al. |
| D503,593 | Apr. 5, 2005 | Walker |
| 5,937,743 | Aug. 17, 1999 | Overstreet |
| 4,517,887 | May 21, 1985 | Childress |
| 4,154,155 | May 15, 1979 | Brignall |
| 4,154,156 | May 15, 1979 | Brignall |
| D249,219 | Sep. 5, 1978 | Stence |
| 3,817,163 | Jun. 18, 1974 | Kizziar et al. |
| 3,745,911 | Jul. 17, 1973 | Kennedy, Jr. et al. |
| 3,693,537 | Sep. 26, 1972 | Johnson, et al. |
| 3,511,172 | May 12, 1970 | Jones |
| 3,020,826 | Feb. 13, 1962 | Silva |
| 2,957,404 | Oct. 25, 1960 | Richardson |
| 2,847,933 | Aug. 19, 1958 | Pate |
| 2,814,981 | Dec. 3, 1957 | Wendel |
| 2,778,294 | Jan. 21, 1957 | Ulloa |
| 2,775,929 | Jan. 1, 1957 | Johnson |
| 2,719,480 | Oct. 4, 1955 | Prickett |
| 6,019,224 | Feb. 1, 2000 | Rich |
| 7,565,864 | Jul. 28, 2009 | Hart |
| D520,814 | May 16, 2006 | Wegmann |

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### THE NAMES OF THE PARTIES TO A JOINT RESEARCH AGREEMENT

Not applicable.

### BACKGROUND OF THE INVENTION

Pre-cooked taco shells are available in retail grocery stores in boxed sealed cellophane packaging commonly in numbers of 10 or more. Consumers wishing to fry and shape their own fresh corn or flour tortillas, must either purchase an existing designed device or hold the tortilla in a open pan over hot frying oil and shape the tortilla to the desired U-shape with forks and/or other cooking utensils. There are various existing patents for the shaping and cooking of fresh tortillas. Existing taco shell fryers are designed to fry either one or multiple (up to four or more) tortillas. Multiple tortillas cookers are designed for total submersion in a suitable deep fryer. Single tortillas cookers may be designed for pans or deep fryers and commonly have handles, or a locking mechanism to hold one perforated plate against an outside perforated plate. Existing designs utilize perforated sheet metal plates in “V” or “U”-shaped mold(s). The plates “press” the tortilla not allowing it to expand with the heat which may not be desirable. Many single tortilla fryers are made with extended fixed handles which may be adjustable to submerge, turn, and extract the tortillas from the hot cooking oil. Such handles may be bulky for storage, and some handles are not completely functional in all conventional cooking methods including pan frying, deep frying and baking. Certain single tortilla cookers have handles that are ineffective or difficult to use when turning the tortilla, or handles that are unsuitable for deep frying or oven baking. Certain existing tortilla cookers limit the size of the tortilla not to exceed the size of the device plates.

### BRIEF SUMMARY OF THE INVENTION

The device is a cooking utensil for soft flat-bread tortillas. The device is multi-functional. It is a mold used to pan-fry, deep-fry, toast, or bake a single soft corn or flour tortilla into a U-shaped finished shell. In addition, the device may be inverted and used as a preparation or serving stand for the cooked tortilla or taco.

### BRIEF DESCRIPTION OF THE SEVERAL VIEWS OF THE DRAWING

The O-rings are designed to slide from the horizontal axes of the form grates to the outside vertical axes of the grates. The O-rings are designed to have 3 positions in utilization of the device.

1. FIG. 1: The “Open position” (FIG. 1) and is utilized to insert the flat tortilla into the lower form grate. The inner grate is raised, allowing the O-rings to drop to the bottom of the upper grate. The Open position of the rings connect the upper grate on the lowest position of it's outside vertical axes, to the outside edges of horizontal axis of the lower grate. The rings are easily moved to the outside edges of the horizontal edge of lower grate due to the position of the rings on the vertical axes of the upper grate.

FIG. 2 shows the placement of the tortilla in the Open position.

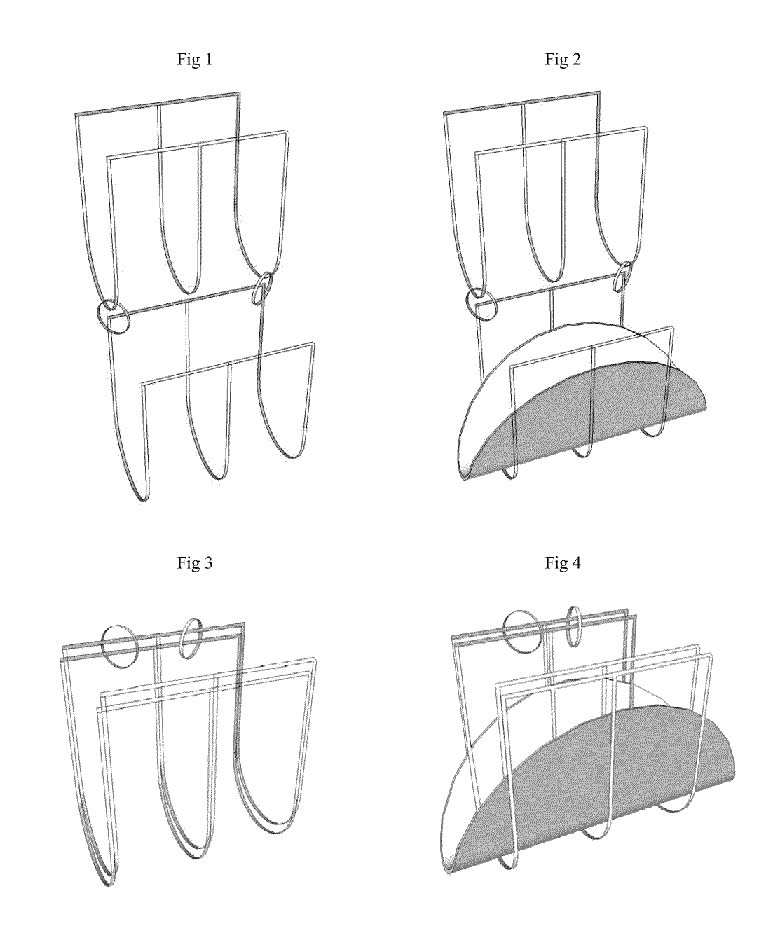

2. FIG. 3: The “Closed/Cooking position” is the position utilized to fry, bake, toast, prepare, or serve the tortilla. The O-rings connect the horizontal axes of the form grates on the rings' respective sides. The rings may move independently along their side of the respective horizontal axes.

FIG. 4 shows the placement of the tortilla in the Cooking position.

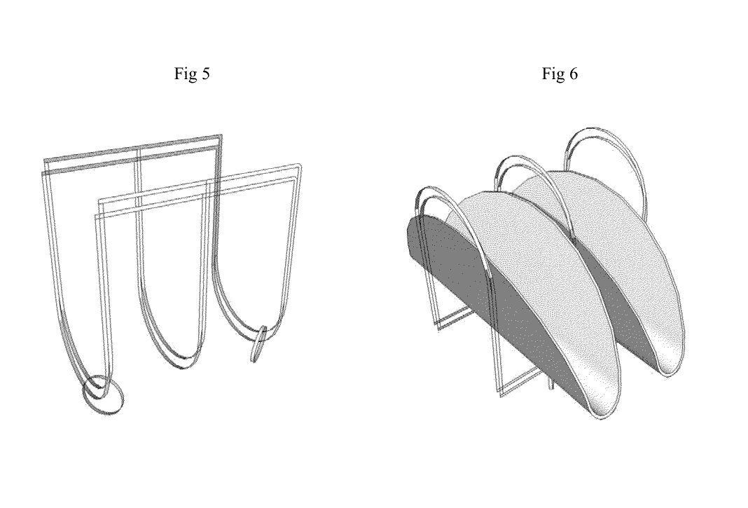

3. FIG. 5: The “Transition position” is utilized to raise or lower the upper grate into or from the tortilla-carrying lower grate. While a tortilla is in the lower grate, the O-rings are above the edges of the tortilla. A transition position is also used to describe those positions in which the devise is empty of a tortilla and the O-rings are free to move along either the vertical or horizontal side(s) of the devise.

4. FIG. 6: The optional preparation/server stand is the inverted position of the Closed position which allows for the placement of 2 (two) cooked tortillas/tacos.

### DETAILED DESCRIPTION OF THE INVENTION

1. The devise is designed for household cooking use made of high-heat durable or metal wire (subject to temperatures up to 500° F.) for repeated use. The device uniquely utilizes O-Rings to hold to the wire grates in place as the tortilla expands while cooking. The O-Rings slide to the sides to open the grates to insert the uncooked or extract the cooked tortilla. One device may be used in a small frying pan with a small level of cooking oil. Two devices may be used simultaneously side-by-side in a 10″ frying pan. The device may be easily rolled in the frying pan with a fork or pair of tongs to complete the cooking of the uncooked side.

2. The device is comprised of two (2) U-shaped form/mold grates connected by two O-rings. One O-ring is connected to each side of the form grates separated by one or more vertical axes of the grates. Both form/mold grates are of similar dimensions and shape. One grate, the “upper” or “inside” grate, has a shorter separation of the horizontal axes (approximately 1/16″) than the “lower” or “outside” grate, allowing it to slide into the outside grate. The full insertion of the upper grate into the lower grate is unnecessary for the cooking functions of the devise, however, alternative use of the devise as a preparation and serving stand, and easy storage require full insertion of the upper grate into the empty lower grate.

3. For purposes of these descriptions, claims and diagrams, the horizontal axis is approximately 3½ inch length and the U-shaped vertical span is approximately 6½ inches. The device in these dimensions accommodates a tortilla of 4 to 7 inch diameter while the diagrams assume an approximate size of 6 inches, and the O-rings approximately 16 mm in diameter.

4. The device retains the U-shaped form of the tortilla by utilizing the resistance pressure of the flat tortilla against the upper and lower forming grates, and by the resistance of the two O-rings connecting the upper and lower form grates. The resistance pressure of the tortilla is increased by the actual frying of the tortilla. The O-rings are intended to be placed on the horizontal grates while cooking, and allow the expansion of the tortilla. The O-rings limit the expansion of the grates while cooking which without, would force the forming grates apart.

5. The materials, preferably stainless steel metal wire or high-heat sensitive metal or microwave safe material) used to construct the device will withstand temperatures exceeding 450 degrees Fahrenheit.

6. In use with cooking oils, the device is designed to be used with either a frying pan or a deep fryer. If used in a frying pan, one side of the device containing the tortilla is placed in (one inch or less of) hot oil for cooking duration, and then the device is turned to the opposite side to complete cooking. If used in a deep fryer the device may be completely submerged in the hot oil with or without a deep fryer basket. If used in a conventional or toaster oven, the devise should be placed in such oven in an inverted U position.

7. The devise is hot when removed from the heat source. To remove from hot oil in a frying pan, a dinner fork may be inserted in the middle horizontal axes of the devise, and lifted to a serving plate. Cooking tongs are recommended for use in removal from a deep fryer or basket. Oven mitts may be used to remove the device from conventional or toaster ovens. The user is cautioned to let the devise cool for 2 minutes before touching the device, lowering rings to the sides and releasing the cooked tortilla. Alternatively, the user may use two dinner forks—one to hold the left-corner/ring, while another to move the right corner ring to the vertical axes, allowing the ring to lower, and the devise to open. The empty device may be dipped in cool water for immediate reuse.

8. The devise may be additionally or alternatively utilized as a taco/tortilla preparation and serving stand (FIG. 6). In a “closed position” of the empty devise, it may be turned to an inverted U position with the horizontal axes on the bottom. This allows two (or more) cooked tacos/tortillas to be placed in the device perpendicular to the horizontal axes. Placing the cooked tortillas in the device in such manner allows the preparer to place assorted meats, cheeses and vegetables in the tortilla as it stands in the U-shape rather than on its side where the preparer must hold the tortilla upright and when returned to its side, contents may spill out. The device/stand including the prepared tortilla(s) may then be placed on a plate and served with side condiments and/or garnishments.

1. The invention is a cooking utensil for soft tortillas comprising two U-shaped metal grills connected by two O-rings all constructed with metal (preferably stainless steel) wire.
a. The metal grills are comprised of two horizontal and three vertical grate lengths with one grill having a horizontal grate separation of approximately ½ cm greater than the other grill to accommodate the tortilla thickness.
b. Two removable O-rings or slip-rings are used to connect the two grills at opposite positions outside the center vertical grates of the two grills providing the mechanism to open the device and place or remove the tortilla, or close the device and secure the tortilla for cooking.
